(19) United States
(12) Patent Application Publication
(10) Pub. No.: US 2011/0153304 A1
(43) Pub. Date: Jun. 23, 2011

(54) CIRCUIT SIMULATION APPARATUS AND TRANSIENT ANALYSIS METHOD FOR PERFORMING TRANSIENT ANALYSIS

(75) Inventor: Junji YAMADA, Tokyo (JP)

(73) Assignee: ELPIDA MEMORY, INC., Tokyo (JP)

(21) Appl. No.: 12/974,670

(22) Filed: Dec. 21, 2010

(30) Foreign Application Priority Data
Dec. 21, 2009 (JP) 2009-288984

(51) Int. Cl. G06F 17/50

(52) U.S. Cl. 703/14

(57) ABSTRACT

A storage section stores a netlist representing a test object circuit. An extracting section extracts, from the netlist stored in the storage section, a subnetlist representing a periodic circuit which is included in the test object circuit and which outputs a periodic output signal corresponding to a periodic input signal. An analyzing section performs transient analysis of the periodic circuit represented by the subnetlist extracted by the extracting section, for one period of the periodic output signal outputted by the periodic circuit. A simulation section performs transient analysis of the test object circuit represented by the netlist stored in the storage section on the basis of the result of the analysis performed by the analyzing section.

### BACKGROUND OF THE INVENTION

1. Field of the Invention

The present invention relates to a circuit simulation apparatus and a transient analysis method.

2. Description of the Related Art

In circuit simulation, transient analysis of a test object circuit in an electric circuit may be performed. In the transient analysis, the state of an output signal corresponding to an input signal in the test object circuit is calculated at a predetermined time interval, and thereby the state change in the output signal is simulated. Note that the calculation of the state of an output signal at each time point is described in JP2004-334605A.

Further, in the transient analysis, a method may be used in which the calculation amount is reduced in such a manner that the calculation interval as the time interval used to calculate the state of the output signal is changed between the period when the input signal is changed and the period when the input signal is not changed. More specifically, in this method, the calculation interval during the period when the input signal is not changed is set longer than the calculation interval during the period when the input signal is changed. Thereby, the number of calculation steps in the period with no change in the input signal is reduced, and hence the calculation amount in the transient analysis is reduced.

However, when a signal, such as a clock signal, which is always changing at high speed, is used as the input signal of the test object circuit, the calculation interval is always short, and hence the calculation amount in the transient analysis of the test object circuit cannot be reduced.

In particular, the clock signal is supplied to the entire electric circuit, and hence is used as the input signal in many test object circuits. For this reason, the fact that it is impossible to reduce the calculation amount in the transient analysis of the test object circuit that uses the clock signal as the input signal has been an obstacle in reducing the time required for the circuit simulation.

### SUMMARY

A circuit simulation apparatus according to the present invention includes a storage section, an extracting section, an analyzing section, and a simulation section.

The storage section stores a netlist representing a test object circuit. The extracting section extracts, from the netlist stored in the storage section, a subnetlist representing a periodic circuit which is included in the test object circuit and which outputs a periodic output signal corresponding to a periodic input signal. The analyzing section performs transient analysis of the periodic circuit represented by the subnetlist extracted by the extracting section, for one period of the periodic output signal outputted by the periodic circuit. The simulation section performs transient analysis of the test object circuit represented by the netlist stored in the storage section on the basis of the result of the analysis performed by the analyzing section.

Further, a circuit simulation apparatus according to the present invention includes a storage section, an extracting section, an analyzing section, and a simulation section.

The storage section stores a netlist representing a test object circuit in an electric circuit. The extracting section extracts, from the netlist stored in the storage section, a subnetlist representing a periodic circuit which is included in the test object circuit and which delays a clock signal of the electric circuit so as to output the delayed clock signal as a periodic output signal. The analyzing section performs, for one period of the clock signal, transient analysis of the periodic circuit represented by the subnetlist extracted by the extracting section. The simulation section performs transient analysis of the test object circuit represented by the netlist stored in the storage section on the basis of the result of the analysis performed by the analyzing section.

Further, a circuit simulation apparatus according to the present invention includes a storage section, an extracting section, an analyzing section, and a simulation section.

The storage section stores a netlist representing a test object circuit. The extracting section extracts, from the netlist stored in the storage section, a subnetlist representing a periodic circuit which is included in the test object circuit and which outputs a periodic output signal corresponding to a periodic input signal. The analyzing section analyzes the transient state of the periodic output signal for one period of the periodic output signal by using the subnetlist extracted by the extracting section. The simulation section performs transient analysis of the test object circuit represented by the netlist stored in the storage section.

Further, a transient analysis method according to the present invention, which is performed by a circuit simulation apparatus including a storage section for storing a netlist representing a test object circuit, includes: extracting, from the netlist stored in the storage section, a subnetlist representing a periodic circuit which is included in the test object circuit and which outputs a periodic output signal corresponding to a periodic input signal; performing transient analysis of the periodic circuit represented by the extracted subnetlist for one period of the periodic output signal outputted by the periodic circuit; and performing transient analysis of the test object circuit represented by the netlist stored in the storage section on the basis of the analysis result of the transient analysis.

As described above, according to the present invention, the transient analysis of the periodic circuit, which is included in the test object circuit and which outputs the periodic output signal, is performed only for one period of the periodic output signal, and the transient analysis of the test object circuit is performed based on the result of the transient analysis of the periodic circuit. Thereby, the calculation amount in the transient analysis of the periodic circuit can be reduced, and hence the calculation amount in the transient analysis of the test object circuit can be reduced.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram showing a configuration of a circuit simulation apparatus according to an exemplary embodiment of the present invention;

FIG. 2 is a circuit diagram showing an example of a test object circuit;

FIG. 3 is a circuit diagram showing an example of a periodic circuit;

FIG. 4 is a figure showing an example of a subnetlist;

FIG. 5 is a figure showing an example of waveforms of a periodic input signal and periodic output signals;

FIG. 6 is a figure showing an example of a calculation netlist;

FIG. 7 is a figure showing an example of a corrected netlist;

FIG. 8 is a flow chart for explaining an example of an operation of the circuit simulation apparatus;

FIG. 9 is a flow chart for explaining an example of an operation of an extracting section; and

FIG. 10 is a flow chart for explaining the other example of the operation of the extracting section.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. Note that in the following description, components having the same function are denoted by the same reference numerals or reference characters, and the explanation thereof may be omitted.

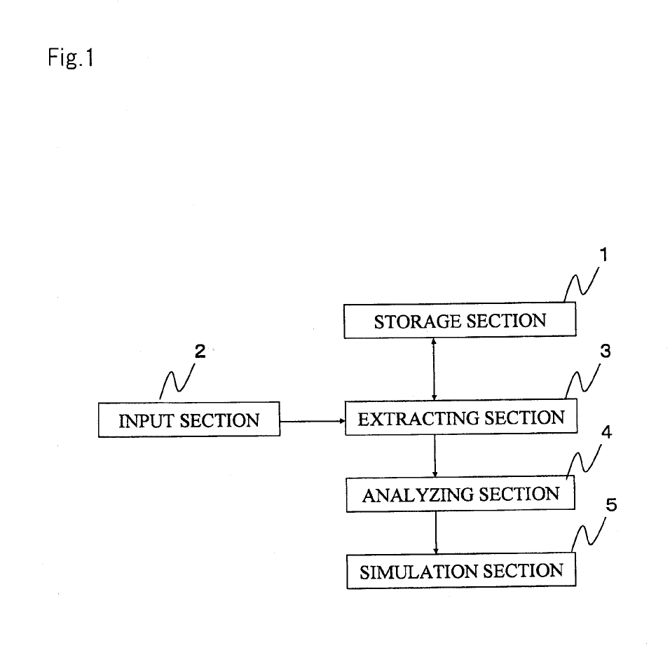

FIG. 1 is a block diagram showing a configuration of a circuit simulation apparatus according to an exemplary embodiment of the present invention. In FIG. 1, the circuit simulation apparatus includes storage section 1, input section 2, extracting section 3, analyzing section 4, and simulation section 5.

Storage section 1 stores a netlist representing a test object circuit in an electric circuit.

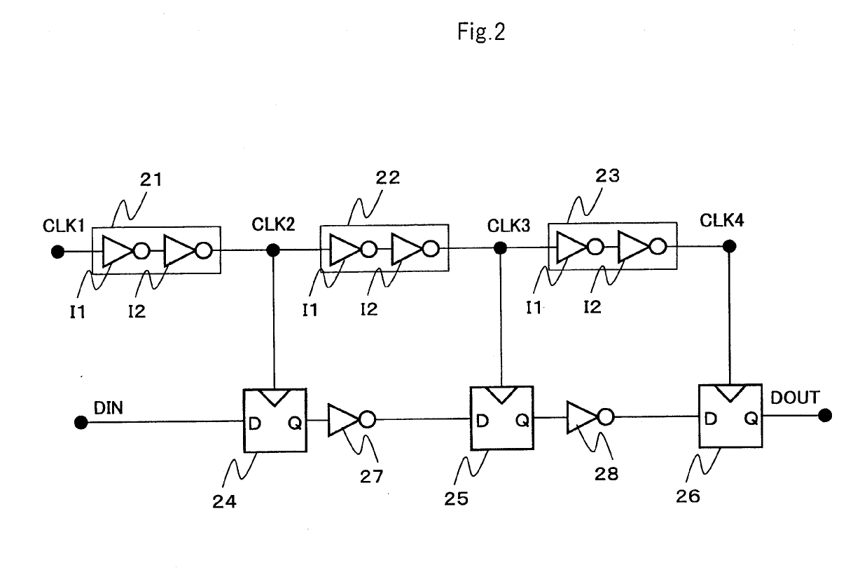

FIG. 2 is a circuit diagram showing an example of the test object circuit. In FIG. 2, the test object circuit includes delay circuits 21 to 23, flip-flops 24 to 26, and inverter circuits 27 and 28.

Each of delay circuits 21 to 23 is configured by inverter circuits 11 and 12 connected in series.

Further, delay circuits 21 to 23 are connected in series. More specifically, the input pin of delay circuit 21 is connected to net CLK1. The output pin of delay circuit 21 is connected to the input pin of delay circuit 22 via net CLK2. The output pin of delay circuit 22 is connected to the input pin of delay circuit 23 via net CLK 3. Further, the output pin of delay circuit 23 is connected to net CLK4.

Note that a net is a wiring which effects a connection between circuits, and is also referred to as a node. Further, a clock signal of the electric circuit is inputted as a CLK1 signal into net CLK1.

Each of flip-flops 24 to 26 is a D-type flip-flop.

In flip-flop 24, a D pin, which is a data input pin, is connected to net DIN, a CK pin, which is a clock input pin, is connected to net CLK2, and a Q pin, which is an output pin, is connected to a D pin of flip-flop 25 via inverter circuit 27. In flip-flop 25, a CK pin is connected to net CLK3 and a Q pin is connected to a D pin of flip-flop 26 via inverter circuit 28. In flip-flop 26, a CK pin is connected to net CLK4 and a Q pin is connected to net DOUT. Note that a data signal is inputted into net DIN.

In delay circuits 21 to 23 configured as described above, the CLK1 signal inputted into net CLK1 is successively delayed by delay circuits 21 to 23, so as to be outputted. More specifically, the CLK1 signal is delayed in delay circuit 21 so as to be outputted as a CLK2 signal to net CLK2. In delay circuit 22, the CLK2 signal inputted into net CLK2 is delayed so as to be outputted as a CLK3 signal to net CLK3. In delay circuit 23, the CLK3 signal inputted into net CLK3 is delayed so as to be outputted as a CLK4 signal to net CLK4.

Further, the data signal inputted into net DIN is held by flip-flop 24 at the rising edge of the CLK2 signal. The data signal held by flip-flop 24 is inverted by inverter circuit 27 and is held by flip-flop 25 at the rising edge of the CLK3 signal. Then, the data signal held by flip-flop 25 is inverted by inverter circuit 28 and is held by flip-flop 26 at the rising edge of the CLK4 signal. The data signal held by flip-flop 26 is outputted from net DOUT.

The description returns to FIG. 1. Input section 2 receives specific information which specifies a periodic circuit included in the test object circuit represented by the netlist stored in storage section 1.

The periodic circuit is a circuit which outputs a periodic output signal corresponding to a periodic input signal inputted into the test object circuit. The periodic input signal, which is a periodically changing signal, is a clock signal, and the like, of the electric circuit including the test object circuit. Further, the periodic circuit is, for example, a circuit which delays the clock signal of the electric circuit so as to output the delayed clock signal as the periodic output signal.

In the exemplary embodiment, the specific information represents an input net that is a net into which the periodic input signal is inputted. Note that a plurality of input nets may be provided.

Extracting section 3 extracts a subnetlist representing a periodic circuit included in the test object circuit from the netlist stored in storage section 1 by using the specific information received by input section 2.

More specifically, extracting section 3 extracts, from the netlist, a subnetlist representing, as the periodic circuit, a circuit leading from an input net specified by the specific information to a net connected to an input pin of a gate having a plurality of input pins.

Note that when a periodic signal is inputted into an input pin of a gate having only one input pin, the output signal of the gate is regarded as a signal formed by delaying the periodic signal, and hence the output signal becomes a periodic signal. On the other hand, even when a periodic signal is inputted into an input pin of a gate having a plurality of input pins, the output signal of the gate depends not only on the periodic signal but also on a signal inputted to the other input pin, and hence the output signal does not generally become a periodic signal.

Therefore, a net connected to an input pin of a gate having a plurality of input pins is regarded as an output net to which a periodic output signal corresponding to a periodic input signal is outputted. Further, the periodic output signal becomes a signal delayed by a gate having only one input pin, and hence the period of the periodic input signal is the same as the period of the periodic output signal.

In the following, the extracting processing performed by extracting section 3 will be specifically described by using the test object circuit shown in FIG. 2.

In the case where the test object circuit has the configuration shown in FIG. 2, the CLK1 signal, which is a clock signal, is inputted into net CLK1, and hence net CLK1 is an input net into which a periodic input signal is inputted. Therefore, the specific information specifies net CLK1.

Further, each of delay circuits 21 to 23 has only one input pin. Thus, the signals of the CLK2 signal to the CLK4 signal, which are respectively outputted to the nets of net CLK 2 to net CLK 4 from delay circuits 21 to 23, are periodic signals which are formed by successively delaying the CLK1 signal. Further, each of the nets of net CLK 2 to net CLK4 is connected to the CK pin of each of flip-flops 24 to 26 each having a plurality of input pins (D pin and CK pin), and hence becomes an output net to which the periodic output signal is outputted.

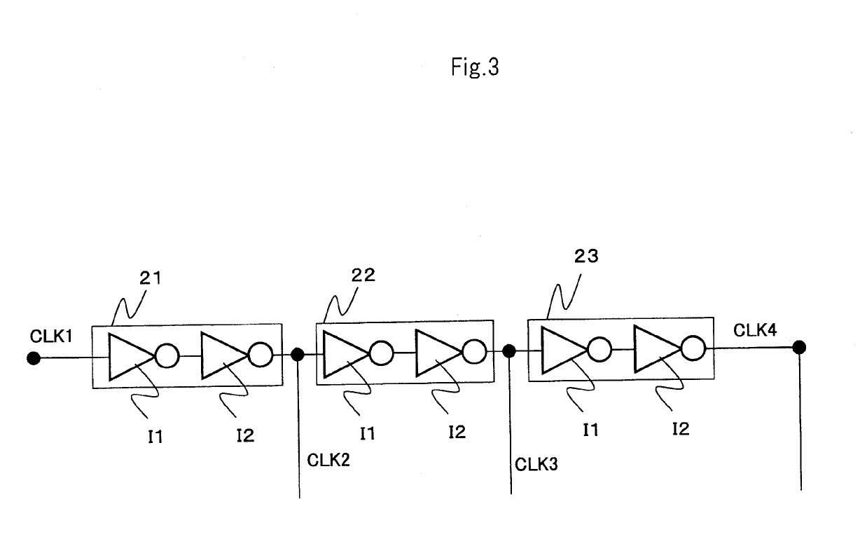

Therefore, extracting section 3 can find the nets of net CLK2 to net CLK4 as the output nets by tracking from net CLK1 specified by the specific information to flip-flops 24 to 26 each of which has the plurality of input pins. As a result, extracting section 3 specifies, as a periodic circuit, the circuit between net CLK1 and each of the nets of net CLK2 to net CLK4, and extracts the subnetlist representing the specified periodic circuit from the netlist stored in storage section 1. Therefore, as shown in FIG. 3, the specified periodic circuit becomes a circuit configured by delay circuits 21 to 23 included in the test object circuit.

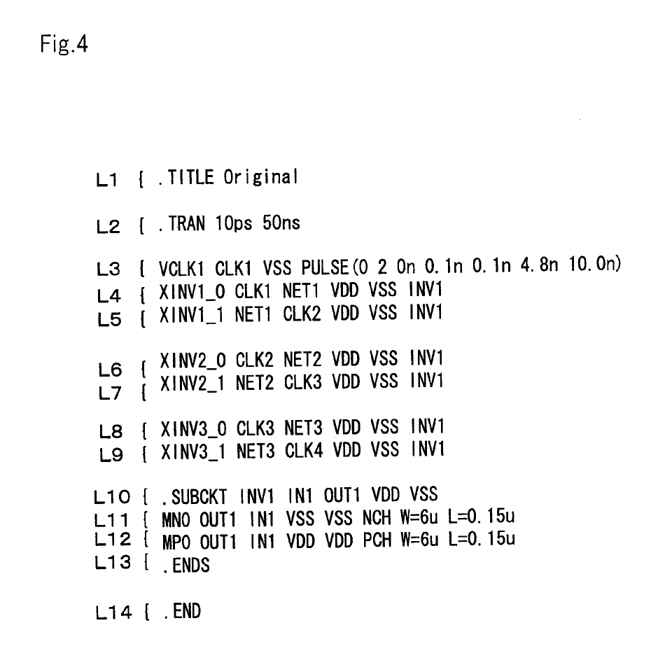

FIG. 4 is a figure showing an example of a subnetlist representing the periodic circuit shown in FIG. 3. Note that FIG. 3 shows a subnetlist for SPICE (Simulation Program with Integrated Circuit Emphasis) which is a general circuit simulation program.

In FIG. 4, the first line (L1) is the beginning of the subnetlist, and represents the title “.TITLE Original” of the subnetlist. Further, “.END” in the last line (L14) represents the end of the subnetlist.

The line (L2) which starts with “.TRAN” represents the condition of transient analysis. More specifically, in the line (L2) which starts with “.TRAN”, the calculation interval “10 ps” and the end time “50 ns” of the transient analysis are represented in this order following “.TRAN”. That is, the line (L2) which starts with “.TRAN” represents that the transient analysis is performed from 0 s to 50 ns at an interval of 10 ps.

The line (L3) which starts with “V” represents a voltage source. More specifically, in the line (L3) which starts with “V”, the voltage source name “VCLK1”, the positive side net name “CLK1”, the negative side net name “VSS”, and the voltage source type “PULSE” are represented in this order. Note that the positive side net and the negative side net are nets connected to the voltage source, and are defined such that current flows from the positive side net to the negative side net via the voltage source.

Here, the voltage source type “PULSE” represents a pulse voltage source which outputs a pulse voltage. As the parameters relating to the voltage source type “PULSE”, the initial voltage value “0” of the pulse voltage, the voltage value “2” at the peak of the pulse, the delay time “0 n”, the rise time “0.1 n”, the fall time “0.1 n”, the pulse width “4.8 n”, and the period “10.0 n” are represented in this order.

Therefore, the line (L3) which starts with “V” represents that a square wave having an amplitude “2 V”, a transition time (rise time and fall time) “0.1 ns”, and a period “10 ns” is outputted to net CLK1. Further, the square wave becomes the CLK1 signal which is the periodic input signal.

A SUBCKT statement (L10 to L13) defines a sub circuit. The line (L10) which starts with “.SUBCKT” represents the represents the first line of a sub circuit definition. In the line (L10), the name “INV1” of the sub circuit, and the nets “IN1 OUT1 VDD VSS” connected to the sub circuit are represented in this order following “.SUBCKT”. Further, “.ENDS” (L13) represents the last line of a sub circuit definition.

Each of the lines (L11 and L12) which start with “M” represents a MOSFET. In each of the lines (L11 and L12), the name of MOSFET, the drain net, the gate net, the source net, the channel, the gate width, and the gate length are represented in this order. Here, in the channel, “NCH” represents the N channel, and “PCH” represents the P channel. Therefore, the line (L11) which starts with “MNO” represents an N-channel MOSFET, and the line (L12) which starts with “MPO” represents a P-channel MOSFET.

Further, the drain net and the gate net of the line (L11) which starts with “MNO” are the same as the drain net and the gate net of the line (L12) which starts with “MPO”. For this reason, the sub circuit represents a CMOS inverter circuit in which an N-channel MOSFET and a P-channel MOSFET are complementarily connected to each other.

The lines (L4 to L9) which start with “X” represent that the sub circuit defined by the SUBCKT statement (L10 to L13) is inserted as an insertion circuit.

In each of the lines (L4 to L9) which start with “X”, the name of the insertion circuit, the name of the nets connected to the insertion circuit, and the name of the sub circuit to be inserted are represented in this order. For example, in the line (L4) which starts with “X”, “XINV1_0” represents the name of the insertion circuit, “CLK1 NET1 VDD VSS” represents the nets connected to the insertion circuit, and “INV1” represents the name of the sub circuit.

As described above, the sub circuit defined by the .SUBCKT statement (L10 to L13) represents a CMOS inverter circuit. Thus, each of the lines (L4 to L9) which start with “X” represents the CMOS inverter circuit, and hence represents each of inverter circuits 11 and 12 of delay circuits 21 to 23. More specifically, the line (L4) which starts with “X” represents inverter circuit 11 of delay circuit 21, and the line (L5) which starts with “X” represents inverter circuit 12 of delay circuit 21. Further, the line (L6) which starts with “X” represents inverter circuit 11 of delay circuit 22, and the line (L7) which starts with “X” represents inverter circuit 12 of delay circuit 22. Further, the line (L8) which starts with “X” represents inverter circuit 11 of delay circuit 23, and the line (L9) which starts with “X” represents inverter circuit 12 of delay circuit 23.

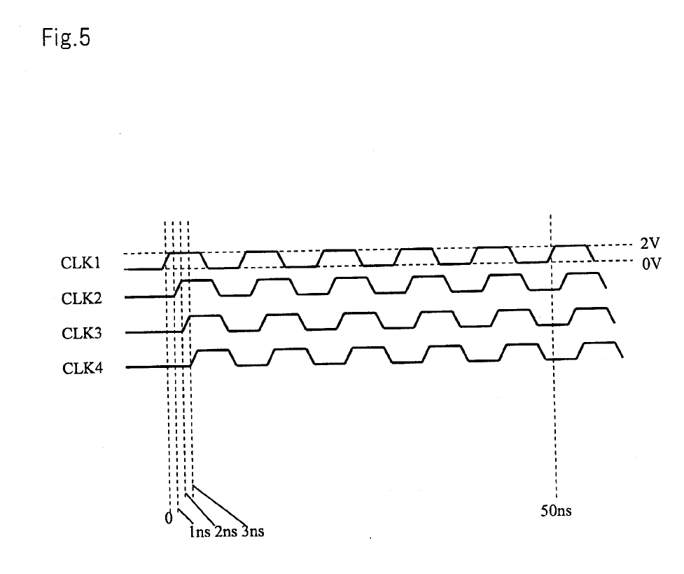

FIG. 5 is a figure showing an example of waveforms of CLK signals generated by the periodic circuit represented by the subnetlist shown in FIG. 4. As shown in FIG. 5, the CLK2 signal is delayed by 1 ns with respect to the CLK1 signal, and the CLK3 signal is delayed by 2 ns with respect to the CLK1 signal. Further, the CLK4 signal is delayed by 3 ns with respect to the CLK1 signal.

The description returns to FIG. 1. Analyzing section 4 performs transient analysis of the periodic circuit represented by the subnetlist extracted by extracting section 3 for one period of the periodic input signal by using the subnetlist, so as to analyze the transient state of the periodic output signal for one period of the periodic output signal.

Simulation section 5 performs transient analysis of the test object circuit represented by the netlist stored in storage section 1 on the basis of the result of the analysis performed by analyzing section 4.

More specifically, simulation section 5 first calculates the delay time of the periodic output signal with respect to the periodic input signal on the basis of the analysis result. For example, simulation section 5 generates a calculation netlist for calculating the delay time of the periodic output signal with respect to the periodic input signal. Then, simulation section 5 calculates the delay time of the periodic output signal by using the calculation netlist.

Subsequently, simulation section 5 converts, based on the calculated delay time, the subnetlist extracted by extracting section 3 to a corrected netlist representing a voltage source which generates the periodic output signal.

Then, simulation section 5 performs transient analysis of the test object circuit by using the corrected netlist. For example, simulation section 5 rewrites the periodic circuit represented by the subnetlist in the netlist with the voltage source represented by the corrected netlist, and performs the transient analysis of the test object circuit based on the rewritten netlist.

In the following, transient analysis processing performed by simulation section 5 will be specifically described by using the subnetlist shown in FIG. 4.

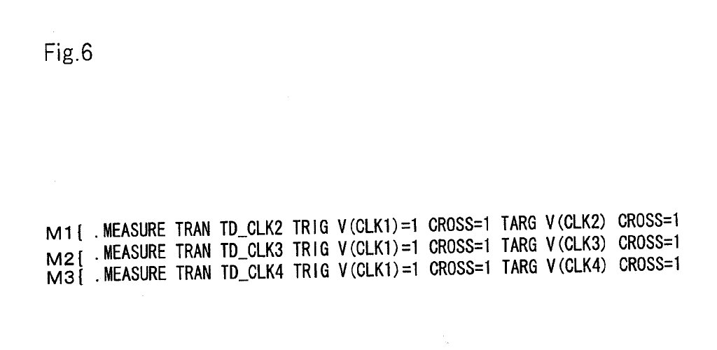

In the case where a subnetlist is configured as shown in FIG. 4, simulation section 5 first generates a netlist shown in FIG. 6 as a calculation netlist which is used to calculate the delay time of the periodic output signal.

FIG. 6 shows MEASURE statements (M1 to M3) for obtaining the delay time of each of the CLK2 signal to CLK4 signal with respect to the CLK1 signal.

In each of the MEASURE statements (M1 to M3), the name of the output file, the measurement start point, and the measurement end point are represented in this order following MEASURE.

For example, in the MEASURE statement (M1), “TRAN TD_CLK2” represents the name of an output file, “TRIG V (CLK1) CROSS =1” represents the measurement start point, and “TARG V (CLK2) CROSS =1” represents the measurement end point.

Note that the measurement start point represents the time when the voltage “V (CLK1)” of net CLK1 becomes “CROSS” (=1), and the measurement end point represents the time when the voltage “V (CLK2)” of net CLK2 becomes “CROSS” (=1).

Therefore, the MEASURE statement (M1) represents that the time period from the time when the voltage of net CLK1 becomes 1 to the time when the voltage of net CLK2 becomes 1 is measured. That is, the MEASURE statement (M1) represents that the delay time of the CLK2 signal with respect to the CLK1 signal is measured.

Similarly, the MEASURE statement (M2) represents that the delay time of the CLK3 signal with respect to the CLK1 signal is measured, and the MEASURE statement (M4) represents that the delay time of the CLK4 signal with respect to the CLK1 signal is measured.

Thereby, simulation section 5 can obtain the output files (TD_CLK2 to TD_CLK4) which respectively represents the delay time of the CLK2 signal to CLK4 signal with respect to the CLK1 signal. Simulation section 5 converts the subnetlist to the corrected netlist based on the delay time represented by the output files.

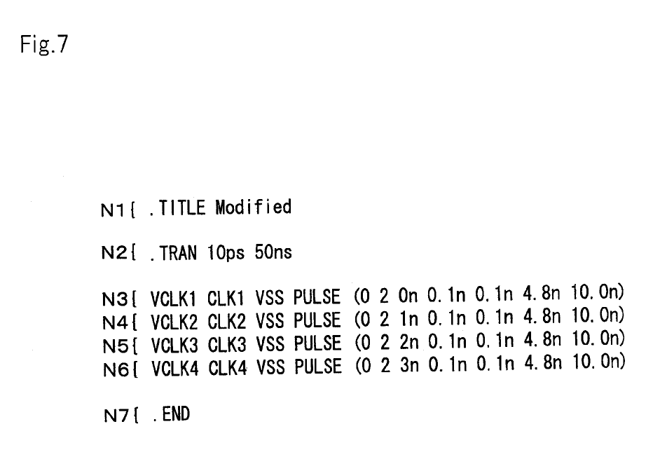

FIG. 7 is a figure showing an example of the corrected netlist. Note that in FIG. 7, the first line (N1) and the last line (N7) respectively represent the beginning and the end of the corrected netlist.

The line (N3) which starts with “V” represents a voltage source that is similar to the line (L3) which starts with “V” and which is shown in FIG. 4. That is, the line (N3) represents a pulse voltage source which outputs the CLK1 signal. Further, each of the lines (N4 to N6) which start with “V” represents a pulse voltage source that is similar to the line (N3) which starts with V. Here, in the voltage sources represented in the lines (N4 to N6) which start with “V”, each of the parameters relating to the voltage source type “PULSE” is the same between the voltage sources except for the delay time. Further, the values of the delay time of the lines (N4 to N6) which start with “V” are set to 1 n, 2 n, and 3 n, respectively. Therefore, it can be seen that the lines (N4 to N6) which starts with “V” respectively represent the power sources which respectively generate the CLK2 signal to CLK4 signal.

Simulation section 5 rewrites the periodic circuit in the netlist with the voltage source represented by the corrected netlist, and performs the transient analysis of the test object circuit based on the rewritten netlist. In the transient analysis, the calculation is performed from 0 ns to 50 ns at the interval of 10 ps as specified in the netlist.

Note that the functions of extracting section 3, analyzing section 4, and simulation section 5 may also be realized in such a manner that a program to realize the functions is recorded onto a recording medium which can be read by a computer, such as a CPU, and that in such a manner the program recorded on the recording medium is read by the computer.

Next, the effect of the exemplary embodiment will be described.

In the exemplary embodiment, extracting section 3 extracts, from a netlist stored in storage section 1, a subnetlist representing a periodic circuit which is included in a test object circuit and which outputs a periodic output signal corresponding to a periodic input signal. Analyzing section 4 performs transient analysis of the periodic circuit represented by the subnetlist extracted by extracting section 3 for one period of the periodic output signal outputted by the periodic circuit. Simulation section 5 performs transient analysis of the test object circuit represented by the netlist stored in storage section 1, on the basis of the result of the analysis performed by analyzing section 4.

For this reason, the transient analysis of the periodic circuit, which is included in the test object circuit and which outputs the periodic output signal, is performed only for one period of the periodic output signal, and the transient analysis of the test object circuit is performed based on the result of the transient analysis of the periodic circuit. Thereby, it is possible to reduce the calculation amount in the transient analysis of the periodic circuit and to reduce the calculation amount in the transient analysis of the test object circuit.

Further, the periodic input signal is a clock signal of the electric circuit in the exemplary embodiment, and hence it is possible to reduce the calculation amount in the transient analysis using the clock signal as the periodic input signal. Thereby, it is possible to reduce the time required for the circuit simulation.

Further, in the exemplary embodiment, input section 2 receives the specific information for specifying the periodic circuit. Extracting section 3 extracts the subnetlist by using the specific information received by input section 2. Thereby, it is possible to easily specify the periodic circuit, and hence it is possible to further reduce the calculation amount in the transient analysis.

Further, in the exemplary embodiment, the specified circuit represents the input net into which the periodic input signal is inputted. Further, extracting section 3 extracts, from the netlist, a subnetlist representing, as the periodic circuit, a circuit leading from the input net specified by the specific information to an output net connected to an input pin of a gate having a plurality of input pins. For this reason, the user only needs to specify the input net, and hence it is possible to reduce the burden of the user.

Next, an operation of the exemplary embodiment will be described.

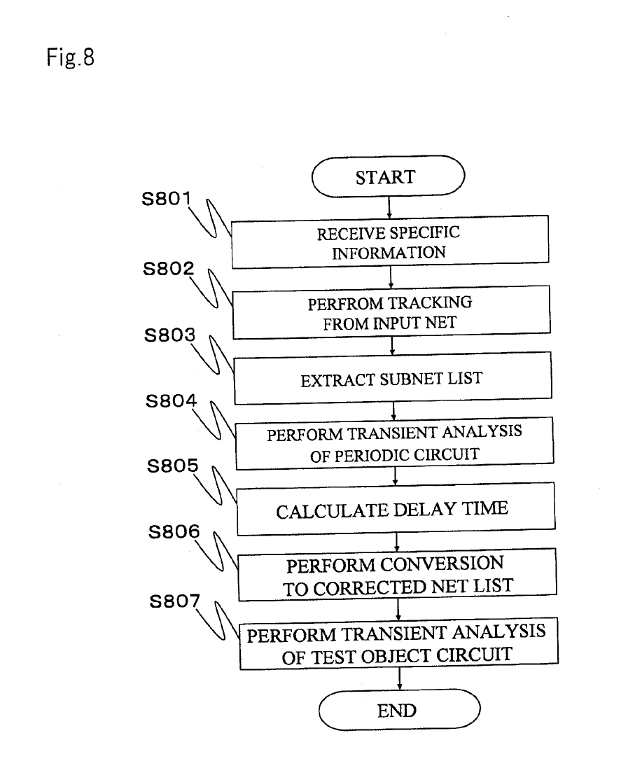

FIG. 8 is a flow chart for explaining an example of an operation of the circuit simulation apparatus.

In step S801, upon receipt of the specific information, input section 2 outputs the specific information to extracting section 3. Upon receipt of the specific information, extracting section 3 performs the processing operation in step S802.

In step S802, extracting section 3 acquires a netlist from storage section 1. Extracting section 3 performs a processing operation to track from the input net represented by the specific information, so as to specify an output net. Then, extracting section 3 performs a processing operation in step S803. Note that when there are a plurality of input nets in step S802, extracting section 3 specifies an output net for each of the plurality of the input nets.

In step S803, extracting section 3 specifies a circuit between the input net and the output net as a periodic circuit, and extracts a subnetlist representing the periodic circuit from the netlist. When there are a plurality of input nets, extracting section 3 specifies, for each of the plurality of input nets, a circuit between the input net and an output net as a periodic circuit.

Extracting section 3 transmits the subnetlist and the netlist to analyzing section 4. Upon receipt of the subnetlist and the netlist, analyzing section 4 performs a processing operation in step S804.

In step S804, analyzing section 4 performs transient analysis of the periodic circuit represented by the subnetlist for one period of a periodic output signal outputted from the periodic circuit. Analyzing section 4 outputs the analysis result, the subnetlist, and the netlist to simulation section 5. Upon receipt of the analysis result, the subnetlist, and the netlist, simulation section 5 performs a processing operation in step S805.

In step S805, simulation section 5 calculates the delay time of the periodic output signal with respect to the periodic input signal on the basis of the analysis result. Then, simulation section 5 performs a processing operation in step S806.

In step S806, simulation section 5 converts the subnetlist to a corrected netlist based on the delay time. Then, simulation section 5 performs a processing operation in step S807.

In step S807, simulation section 5 rewrites the periodic circuit represented by the subnetlist included in the netlist with the voltage source represented by the corrected netlist, and performs the transient analysis of the test object circuit based on the rewritten netlist. Thereby, the operation is completed.

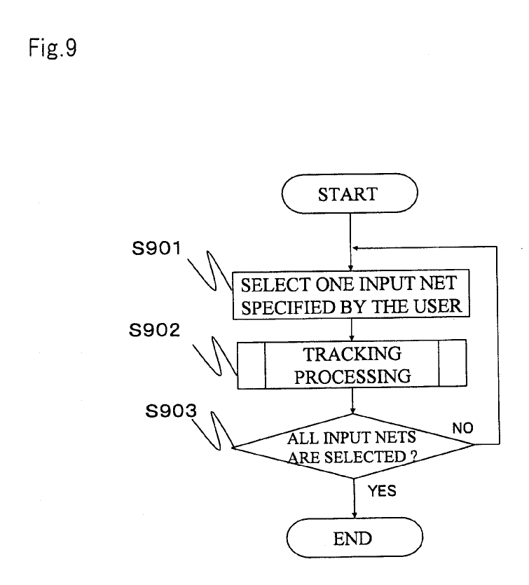

Next, the tracking processing operation performed by extracting section 3 in step S802 will be described in detail. FIG. 9 is a flow chart for explaining an example of the tracking processing operation.

Upon acquisition of the netlist in step S802, extracting section 3 performs the tracking processing (step S901).

In step S901, extracting section 3 selects one input net represented by the specific information. Then, extracting section 3 performs a processing operation in step S902.

In step S902, extracting section 3 tracks the wiring from the input net to a gate having a plurality of input pins, and specifies an output net corresponding to the input net. Then, extracting section 3 performs a processing operation in step S903.

In step S903, extracting section 3 determines whether or not all the input nets have been selected in step S901. When all the input nets have been selected, extracting section 3 ends the tracking processing operation. When all the input nets have not been selected, extracting section 3 returns to step S901.

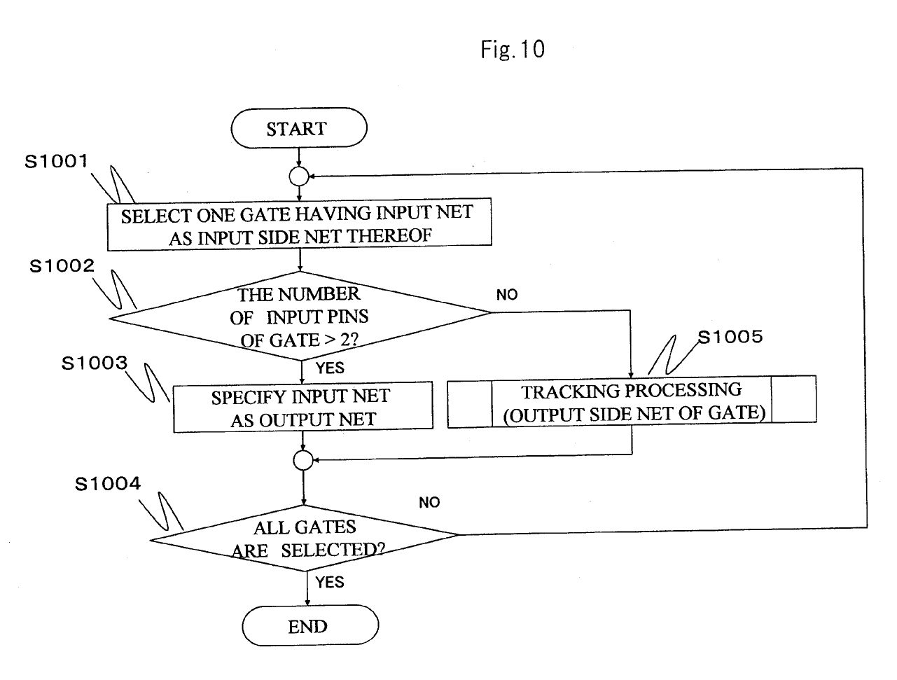

FIG. 10 is a flow chart for explaining an example of a processing operation performed by extracting section 3 in step S902.

In step S1001, extracting section 3 selects one gate which has the input net as the input side net thereof. Then, extracting section 3 performs a processing operation in step S1002.

In step S1002, extracting section 3 counts the number of the input pins of the selected gate, so as to determine whether or not the number of the input pins is at least two. When the number of the input pins is at least two, extracting section 3 performs the processing in step S1003. When the number of the input pins is less than two, extracting section 3 performs the processing in step S1005.

In step S1003, extracting section 3 registers the input net as an output net. Then, extracting section 3 performs a processing operation in step S1004.

In step S1004, extracting section 3 determines whether or not all the gates, each having the input net as an input side net thereof, have been selected. When all the gates have been selected, extracting section 3 specifies the registered output net as the output net corresponding to the input net, and ends the processing operation.

In step S1005, extracting section 3 tracks the net on the output side of the gate selected in step S1001, and searches an output net.

More specifically, extracting section 3 selects one gate having, as the input side net, the output side net of the gate selected in step S1001, and performs the same processing operation as described in this flow chart, so as to search a gate having at least two input pins. Extracting section 3 specifies, as an output net, the input side net of the gate found by the search. Then, extracting section 3 performs a processing operation in step S1004.

In this way, a circuit simulation apparatus according to an exemplary embodiment is configured by including: storage section (1) which stores a netlist representing a test object circuit; extracting section (3) which extracts, from the netlist stored in storage section (1), a subnetlist representing a periodic circuit that is included in the test object circuit and that outputs a periodic output signal corresponding to a periodic input signal; analyzing section (4) which performs transient analysis of the periodic circuit represented by the subnetlist extracted by extracting section (3), for one period of the periodic output signal outputted by the periodic circuit; and simulation section (5) which performs transient analysis of the test object circuit represented by the netlist stored in storage section (1), on the basis of the result of the analysis performed by analyzing section (4).

Further, the circuit simulation apparatus according to the exemplary embodiment is configured to use, as the periodic input signal, a clock signal of an electric circuit including the test object circuit.

Further, the circuit simulation apparatus according to the exemplary embodiment is configured by further including input section (2) which receives specific information for specifying the periodic circuit, and is configured such that extracting section (3) extracts the subnetlist by using the specific information received by input section (2).

Further, the circuit simulation apparatus according to the exemplary embodiment is configured such that the specific information specifies an input net, and such that extracting section (3) extracts a subnetlist which represents, as the periodic circuit, a circuit leading from the input net specified by the specific information to a net connected to an input pin of a gate having a plurality of input pins.

Further, a circuit simulation apparatus according to an exemplary embodiment is configured by including: storage section (1) which stores a netlist representing a test object circuit in an electric circuit; extracting section (3) which extracts, from the netlist stored in storage section (1), a subnetlist representing a periodic circuit that delays a clock signal of the electric circuit so as to output the delayed clock signal as a periodic output signal; analyzing section (4) which performs, for one period of the clock signal, transient analysis of the periodic circuit represented by the subnetlist extracted by extracting section (3); and simulation section (5) which performs transient analysis of the test object circuit represented by the netlist stored in storage section (1), on the basis of the result of the analysis performed by analyzing section (4).

Further, a circuit simulation apparatus according to an exemplary embodiment is configured by including: storage section (1) which stores a netlist representing a test object circuit; extracting section (2) which extracts, from the netlist stored in storage section (1), a subnetlist representing a periodic circuit that is included in the test object circuit and that outputs a periodic output signal corresponding to a periodic input signal; analyzing section (4) which analyzes the transient state of the periodic output signal outputted by the periodic circuit represented by the subnetlist extracted by extracting section (2), by using the subnetlist for one period of the periodic output signal; and simulation section (5) which performs transient analysis of the test object circuit represented by the netlist stored in storage section (1) on the basis of the result of the analysis performed by analyzing section (4).

Note that the exemplary embodiments described above are merely exemplary in nature. The present invention is not limited to the above described exemplary embodiments, and various modifications and variations are possible within the scope and spirit of the present invention.

For example, the specific information may directly specify an output net. In this case, it is not necessary to perform the tracking processing, and hence the calculation amount can be further reduced.

Further, extracting section 3 may search a pulse voltage source in the netlist, so as to specify the positive side net of the pulse voltage source as an input net. In this case, the user need not input the specific information, and hence it is possible to reduce the burden of the user.

What is claimed is:

1. A circuit simulation apparatus comprising:
a storage section which stores a netlist representing a test object circuit;
an extracting section which extracts, from said netlist stored in said storage section, a subnetlist representing a periodic circuit that is included in said test object circuit and that outputs a periodic output signal corresponding to a periodic input signal which is a periodically changing input signal;
an analyzing section which performs transient analysis of said periodic circuit represented by said subnetlist extracted by said extracting section, for one period of said periodic output signal outputted by said periodic circuit; and
a simulation section which performs transient analysis of said test object circuit represented by said netlist stored in said storage section on said basis of a result of said analysis performed by said analyzing section.

2. The circuit simulation apparatus according to claim 1, wherein said periodic input signal is a clock signal of an electric circuit including said test object circuit.

3. The circuit simulation apparatus according to claim 1, further comprising
an input section which receives specific information for specifying said periodic circuit,
wherein said extracting section extracts said subnetlist by using said specific information received by said input section.

4. The circuit simulation apparatus according to claim 3, wherein
said specific information specifies an input net into which said periodic input signal is inputted, and
said extracting section extracts a subnetlist which represents, as said periodic circuit, a circuit leading from said input net specified by said specific information to a net connected to an input pin of a gate having a plurality of input pins. 10

5. A circuit simulation apparatus comprising:
a storage section which stores a netlist representing a test object circuit;
an extracting section which extracts, from said netlist stored in said storage section, a subnetlist representing a periodic circuit that is included in said test object circuit and that outputs a periodic output signal corresponding to a periodic input signal which is a periodically changing input signal;
an analyzing section which analyzes said transient state of said periodic output signal for one period of said periodic output signal by using said subnetlist extracted by said extracting section; and
a simulation section which performs transient analysis of said test object circuit represented by said netlist stored in said storage section on said basis of a result of said analysis performed by said analyzing section.

6. A transient analysis method performed by a circuit simulation apparatus including a storage section for storing a netlist representing a test object circuit, the transient analysis method comprising:
extracting, from said netlist stored in said storage section, a subnetlist representing a periodic circuit which is included in said test object circuit and which outputs a periodic output signal corresponding to a periodic input signal which is a periodically changing input signal;
performing transient analysis of said periodic circuit represented by said extracted subnetlist for one period of said periodic output signal outputted by said periodic circuit; and
performing transient analysis of said test object circuit represented by said netlist stored in said storage section on said basis of the analysis result of the transient analysis of said periodic circuit.

7. The transient analysis method according to claim 6,
wherein said input signal is a clock signal of an electric circuit including said test object circuit.

8. The transient analysis method according to claim 6, further comprising:
receiving specific information for specifying said periodic circuit,
wherein said extracting extracts said subnetlist by using said received specific information.

9. The transient analysis method according to claim 8,
wherein said specific information specifies an input net into which said periodic input signal is inputted, and
wherein said extracting extracts a subnetlist which represents, as said periodic circuit, a circuit leading from said input net specified by said specific information to a net connected to an input pin of a gate having a plurality of input pins.
